(19) United States
(12) Patent Application Publication
(10) Pub. No.: US 2016/0137458 A1
(43) Pub. Date: May 19, 2016

(54) TRANSPORTATION SYSTEM

(71) Applicant: Michael GODWIN, Cagnes-sur-Mer (FR)

(72) Inventor: Michael Godwin, Cagnes-sur-Mer (FR)

(21) Appl. No.: 14/896,376

(22) PCT Filed: Jun. 4, 2014
(86) PCT No.: PCT/GB2014/051732

§ 371 Date: Dec. 5, 2015

(30) Foreign Application Priority Data
Jun. 5, 2013 (GB) 1310023.5

(51) Int. Cl. B66B 11/04; B66B 7/04; B66B 9/00

(52) U.S. Cl. CPC B66B 11/043; B66B 9/00; B66B 7/042

(57) ABSTRACT

A transportation system includes a track structure supporting one or more tracks along which cabins may travel. The track structure (2) contains the means of propulsion and extends the full length of travel of the cabins (1) and supports and guides the passenger carrying cabin(s). The means of propulsion is generated by connecting the passenger carrying cabin(s) to a rod (32) that successively engages a number of pairs of pinch rollers (41, 42) which are each driven by motors (42) located along the track (2). The pinch rollers are arranged such as to provide the necessary clamping force such that they propel the rod in the direction of travel without slip. The transportation system is suitable for installation both internal and external to building structures and enables cabins to be transported vertically, horizontally and around curved geometries.

### TECHNICAL FIELD OF THE INVENTION

The present invention relates to a transportation system, and particularly but not exclusively to a transportation system for the movement of passengers and/or goods within, around, or external to a building structure.

### BACKGROUND TO THE INVENTION

Multi-storey buildings are routinely provided with lifts (also known as elevators) for the movement of passengers and goods between floors. Conventional lifts are typically suspended by steel ropes in a lift shaft and generally have a counterweight. This limits the number of lift cars per shaft, usually to one. Lift shafts are often the largest space-occupying element of a high rise building core, so this limitation can impair the efficiency of a building in terms of transportation flow and/or usable floor area.

Furthermore, such ropes and counterweights are typically anchored within a lift shaft to form a traction hoist upon which the lift cabin and counterweight are constrained to travel reciprocally in opposite vertical directions. This is incompatible with a horizontal or looped trajectory, for example.

Objects of embodiments of the present invention include the provision of a transportation system that overcomes some or all of the above limitations. Such a transportation system may allow a lift cabin to travel along curved and/or looped trajectories and geometries, providing greater flexibility in the transportation of passengers and goods in and around buildings and structures.

### SUMMARY OF THE INVENTION

According to the present invention, there is provided a transportation system comprising a cabin, a track along which the cabin is movable, an elongate traction member mounted on one of the cabin and the track, and a plurality of pinch rollers mounted on the other of the cabin and the track, wherein at least one said pinch roller is motor driven to propel the cabin along the track by frictional engagement of the pinch rollers with the traction member.

The cabin may be supported on the track by said engagement of the motor-driven pinch roller(s) with the traction member.

The transportation system may comprise at least one opposed pair of pinch rollers, wherein one of the pair is driven by a motor. The other of the pair may be passive. The cabin may be drivable along the track by engagement of the traction member between successive pairs of pinch rollers.

The traction member may comprise a traction rail having the form of a rod, bar, or plate. The traction rail may have tapered ends, may be straight or arcuate, and may have a substantially circular or substantially elliptical cross-section.

The traction member and/or one or more pinch rollers may comprise an ultra-high-strength alloy, such as an ultra-high-strength steel alloy. In a preferred embodiment, the traction member and/or one or more pinch rollers may comprise a maraging steel alloy, such as a grade 250, grade 300, or grade 350 maraging steel.

The traction member may comprise a web on which the traction rail is supported, which may be a plate projecting laterally from the traction rail such that a central longitudinal axis of the traction rail lies within or parallel to a plane defined by the web. The web may project from a region of the traction rail located substantially halfway along its length. The web and traction rail may be welded together or cast as a single piece.

In certain embodiments, the traction member may be mounted on the cabin and the pinch rollers mounted on the track.

In other embodiments, the traction member may be mounted on the track and the pinch rollers mounted on the cabin.

The transportation system may comprise one or more guide(s) for maintaining alignment between the cabin and the track. The or each guide may comprise a linear bearing, and may comprise a guide rail and a guide shoe arranged to receive and/or contact the guide rail, one of the guide rail and shoe being mounted on the cabin and the other being mounted on the track. The cabin may be supported by one or more guide support element(s), the/each guide support element having at least one guide rail or guide shoe mounted thereupon, such two guide rails or guide shoes mounted on opposite sides of the guide support element. The traction member may be mounted on the guide support element. The cabin may be entirely supported on one or more said guide support elements, such as entirely supported on a single said guide support element.

The opposed pinch rollers may be urged together by resilient biasing means, which may comprise a high-stiffness spring, and may be adjustably preloaded, such as by means of a helically threaded adjuster. Separation of the opposed pinch rollers may be accommodated by flexion of a structural element, which may be a part of a beam on which the opposed pinch rollers are mounted, such as a part of the web of an I-beam aligned with the axial direction of the track.

The motor-driven roller may be driven via a reduction gear transmission assembly, and the roller or motor may be coupled to an electromagnetic and/or friction brake. The gear transmission assembly may be arranged, e.g. by virtue of its gear reduction ratio, such that when the motor is unpowered, the cabin when fully loaded transmits no torque, or substantially no torque, to the motor, or transmits insufficient torque to the motor to turn it. Alternatively, the gear transmission assembly may be arranged such that when the motor is unpowered, the weight of the cabin can transmit sufficient torque to the motor to turn the motor at a rate that allows the cabin to descend along a vertical portion of the track at a restricted and/or predefined speed. The system, motor, gear transmission, and/or brake may be arranged to dissipate mechanical energy in a controlled manner in the event of power loss to the motor, so as to decelerate a moving cabin and/or to allow it to descend slowly under gravity to a predefined location, such as the nearest floor in a building.

The transportation system may be arranged so that, when the traction member is fully engaged between a pair of opposed pinch rollers, the traction member is gripped sufficiently tightly between said opposed pinch rollers that no slip between the traction member and opposed pinch rollers is permitted. For example, the grip may be sufficiently tight that no slip occurs even when, in use, the cabin is fully loaded, and/or propelled at a maximum permitted level of acceleration or deceleration, and/or experiences an abrupt loss of motor power while the cabin is descending at a maximum permitted velocity.

The transportation system may be a transportation system in or on a building, may be a passenger transportation system, and may be an elevator. The cabin may be an elevator car. The track may form, or may be mounted on, part of a building structure, such as within an elevator shaft.

At least a portion of the track may be axially aligned in a substantially vertical direction, at least a portion of the track may be axially aligned in a substantially horizontal direction, and at least a portion of the track may define a curved path along which one or more said cabins are drivable. The track may define a closed path along which one or more said cabins are drivable, and may comprise two or more said cabins. The track may extend at least the full distance along which the or each cabin is drivable. The cabin may be rotatably supported, such as rotatably supported on the support element. The cabin may be rotatable about an axis of curvature of the path, and may be rotatable through multiple revolutions relative to the guide, support element, track axis, and/or traction member, such as through an unlimited number of revolutions.

The traction member may be flexibly supported, such as slidably and/or rotatably supported. For example, the traction member may be supported on a hinged, compliant, and/or floating mechanical connection. The traction member may be supported at a location substantially halfway along its length.

One or more said pinch roller may each comprise an outer circumferential bearing surface that substantially conforms to a corresponding surface portion of the traction member when viewed in an axial direction of the track. For example the outer bearing surface may be substantially cylindrical and the traction may comprise a substantially flat surface with which the pinch roller engages; the outer bearing surface may have a concave profile, i.e. forming a circumferentially notched, grooved, or waisted cylinder shape, and the traction rail may comprise a convex surface, such as a substantially cylindrical or elliptical surface; the outer bearing surface may have a convex profile, and may engage with a concave surface portion of the traction rail, such as a longitudinal groove in the traction rail.

The transportation system may comprise a traction member having two or more traction rails, may comprise two or more traction members, may comprise two or more tracks, and may comprise two or more guide support elements. For example, two or more traction members or traction rails may be substantially axially aligned with one another, may be axially spaced from one another, and/or may be transversely spaced from one another.

### DETAILED DESCRIPTION OF THE INVENTION

In order that the invention may be more clearly understood, embodiments thereof will now be described, by way of example only, with reference to the accompanying drawings, of which:

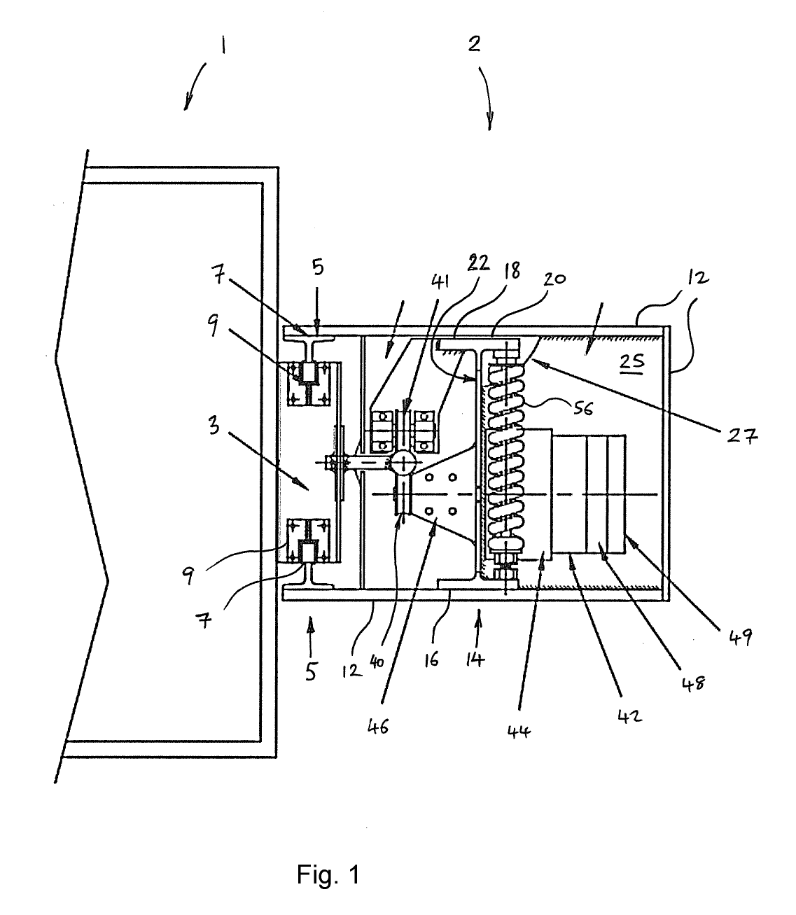

FIG. 1 is a cross-section of part of a transportation system showing a cabin, such as an elevator car, and a supporting track;

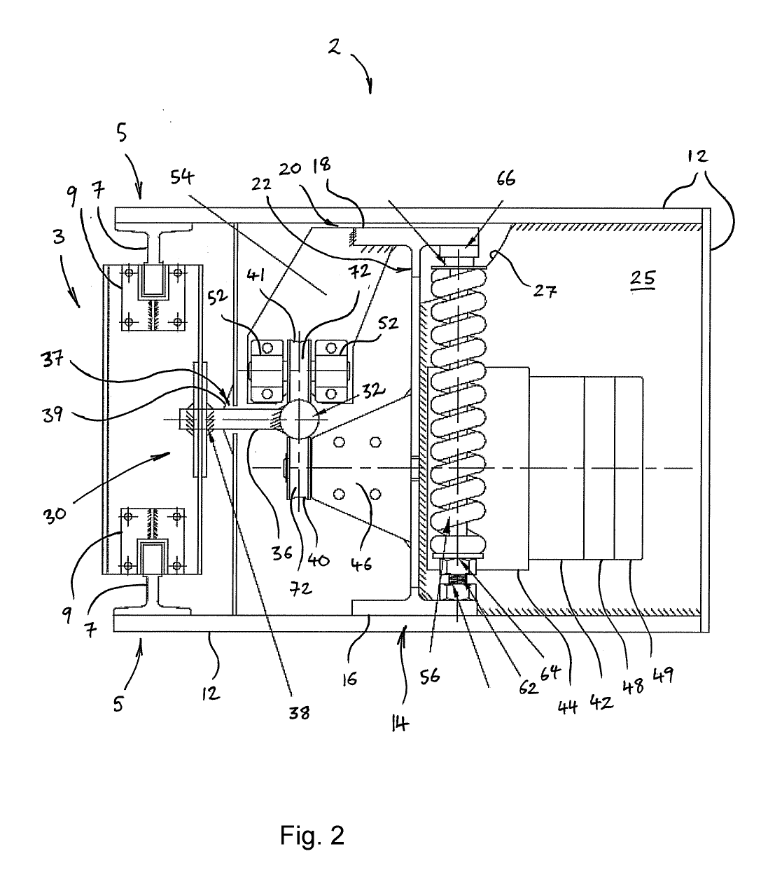

FIG. 2 is an enlarged cross-section of the track of FIG. 1; and

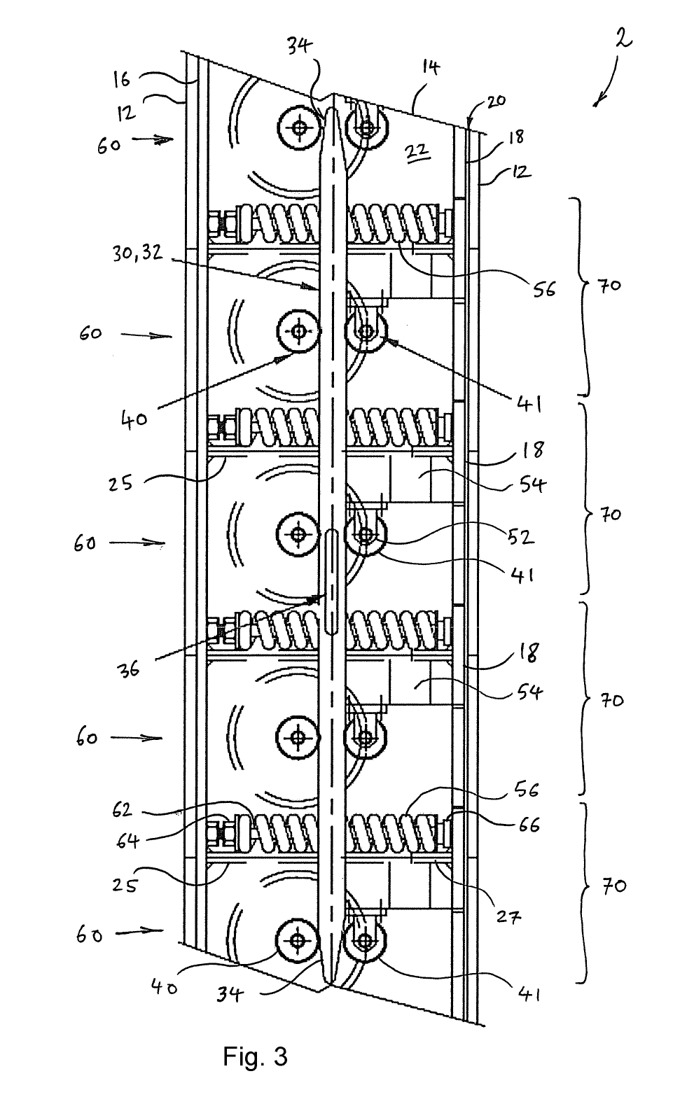

FIG. 3 is a cut-away sectional side view of the track of FIG. 1.

The transportation system illustrated in FIGS. 1 to 3 is a preferred embodiment of the present invention. As shown, there is a passenger-carrying cabin (1) supported on an elongate frame (2) that has a generally box-shaped, C-shaped, or U-shaped cross section and forms a track along which the cabin (1) is propelled. The cabin (1) is securely mounted on a supporting guide frame (3) which is located on the track (2) by guides (5) on opposite sides of the support frame (3). The guides (5) comprise guide rails (7) mounted on the inside of the track (2) and corresponding guide shoes (9) on opposite sides of the guide support frame (3) and engaging with the guide rails (7) to provide sliding support.

The track (2) has an outer wall (12) formed as three plates joined together, such as by longitudinal welds, although it may alternatively be formed as a single structural element such as a C-beam or U-beam. As shown in FIG. 1, all other parts of the track are contained within the outer wall (12), and all moving parts including the guide support frame (3) are enclosed by the outer wall (12) and the cabin (1). An I-beam (14) aligned with the longitudinal axis of the track (2) is welded along one flange (16) to the outer wall (12), while the other flange (18) is spaced from the opposite outer wall by a small gap (20), so that under large forces the I-beam's web (22) is free to deflect laterally about the longitudinal axis, so that the free flange (18) twists or rotates. Slots or openings in the free side of the I-beam may be provided to facilitate this transverse flexion about the central axis.

A reinforcing plate (25) is welded into the outer wall (12) to form a transverse stiffening web within the track (2). It is also welded part-way across the web of the I-beam (14), and has a corner cut away (27) where the weld ends, so that the I-beam (14) and outer wall (12) are further stiffened and reinforced, only a limited portion of the I-beam's web (22) being allowed to deflect laterally as discussed above.

Projecting into the track (2) from the guide support frame (3) is a traction member (30) which has the form of a generally cylindrical rail (32) with tapered ends (34) and a wing (36) cast into or welded onto the rail (32) halfway along its length. The wing (36) is anchored to the guide support frame (3) on a floating mechanical connection (38) or rotating bearing, so that the traction member (30) can flex or rotate to a limited degree relative to the cabin (1). The wing (36) passes through a longitudinal slot (37) in the track (2) which is closed by brushes or flexible strips (39), so that the traction rail (32) is housed within a substantially sealed protective enclosure.

Many pairs (60) of opposed pinch rollers (40, 41) are mounted on the I-beam (41), as shown in FIG. 3, so that the traction rail (32) passes between successive pairs of rollers as the cabin (1) moves along the track (2). One such pair of pinch rollers is shown in FIGS. 1 and 2. One of the rollers (40) is driven by an electric motor (42), via a speed-reducing gearbox (44) and bearing block (46). The motor-driven roller (40), against which the passive roller (41) firmly clamps the traction rail (32), advances the traction rail along the track (2) to propel the cabin (1). The motor (42) is equipped with an encoder (48) and a failsafe electromagnetic and/or friction brake (49) capable of safely bringing the cabin to a stop within a reasonable time. The other roller (41) is supported between a pair of radial bearings (52) on an arm (54) welded to one side of the free flange (18) of the I-beam (14). The bearing arm (54) thus forms part of a resilient cantilever, deflection of which permits separation of the opposed pinch rollers (40, 41) to accommodate and grip the traction rail (32). A high-stiffness helical compression spring (56) acts on the other side of the flange (18) to exert a large clamping force on the pinch rollers, so that the traction rail is very securely gripped between the rollers.

The clamping forces, contact pressures, elastic and frictional properties of the traction rail (32) and pinch rollers (40, 41), and the spacing between successive pairs (60) of pinch rollers, are optimised to ensure that sufficient traction is provided to enable the motors to propel the cabin along the track without any slip occurring between the rollers (41, 42) and the traction rail (32). For example, where higher loads, accelerations, and/or decelerations are expected locally over certain regions of the path travelled by the cabin—such as regions within which a nonlinear track is substantially vertically aligned—the spacing between springs and/or successive pairs of pinch rollers may be lessened, and/or the clamping pressures between rollers within each pair may be increased, so as to optimise grip to prevent slipping while, at the same time, efficiently moderating the total number of roller pairs needed and the clamping loads and wear to which they will be subjected during use. For example, in the track section shown in FIG. 3, the contact surface of the traction rail (32) almost spans five pinch-roller pairs (60), so that the traction rail maintains contact with at least three and no more than four pinch-roller pairs (60) at all times; in other embodiments, or elsewhere on the same track, the longitudinal pinch-roller spacing (relative to the traction rail length) may be varied to increase or decrease the number of pinch-roller pairs with which the traction rail simultaneously engages, so as to increase or decrease the local propulsive force without loss of traction.

Each spring (56) encloses a threaded bar (62) on which the spring (56) can be adjustably preloaded by means of an adjustment nut (64) to provide the correct clamping load and stiffness, enabling these to be varied locally depending on the strength of grip required at each location along the track. At least one end of the threaded bar (62) is simply supported on a bearing (66), such as a floating collar or a hinge or ball bearing, so that the spring's reaction force is transmitted between the free and fixed flanges (18, 16) of the I-beam (14) along the bar's axis, without causing significant shear force or bending moment at the simply-supported end(s) of the bar (62) that could otherwise counteract the clamping effect of the spring reaction force.

In FIGS. 1 to 3, the track (2) comprises a repeating unit (70) of one pinch-roller pair (60) loaded, on one side of the central I-beam (14), by a single motor (42) and a single compression spring (56) located on the other side of the I-beam (14). Where loading is expected to vary along the track, the spacing between repeated units (70) may be varied to ensure adequate propulsion without slip, as discussed above. Further variations on this format are possible, as will be apparent to the skilled reader. For example, instead or in addition: other types of spring or other resilient biasing means may be used; a tensile spring may be provided on the same side of the I-beam (14) as the pinch rollers (40, 41); more than one spring may be provided per pinch-roller pair (60); both rollers in a pair may be motor driven; and/or two or more passive rollers (41) may be provided per motor-driven roller (40).

Within the transient regions of contact between a pair (60) of pinch rollers (40, 41) and the traction rod (32) engaged between them, the concavely arcuate profile of the outer circumferential surface (72) of each pinch roller substantially conforms to the rod's circular cross-section. However, as will be appreciated by the skilled reader, one or both pinch rollers may provide a convex contact surface against a concave surface of the traction rail, and/or a cylindrical roller may contact a flat contact surface of the traction rail. Where the pinch rollers are sufficiently compliant, the degree of conformity is less critical. However, to achieve and withstand the extremely high contact pressures necessary to support and propel the weight of a heavy cabin—contact pressures which may exceed 1 GPa and may exceed 10 GPa—the pinch rollers and traction rail are preferably formed of one or more ultra-high-strength alloys, and preferably have bearing surfaces that conform to one another within extremely small contact tolerances, such as sub-micron contact tolerances.

A flat contact surface may be preferable, for example, in embodiments where the track has a significant curvature. This is particularly suitable where the track curvature varies along its length, while constant track curvature could be accommodated by using a correspondingly curved traction rail. However, the floating or rotating mechanical bearing (38) by which the traction member (30) is anchored to the cabin (1) in combination with the tapered, self-aligning ends (34) of the traction rail (32) and the compliance of the pinch rollers (40, 41), the traction rail (32), and/or the springs (56)—may accommodate a moderate degree of curvature of the track (2). This allows the cabin to follow a nonlinear or partially nonlinear path, which facilitates the retrofitting of elevators into irregular buildings, e.g. old buildings, provides architectural design freedom in new buildings, and allows the provision of a looped track so that the cabin follows a closed path. In particular, a closed path allows multiple, independently driven cabins (1) to travel on the same track (2), increasing the carrying capacity of the transportation system.

Overall control of the individual pinch roller motor assemblies is provided via an electronic bus, such as an Ethernet connection. Suitable speed patterns for the motors to follow in synchronism are provided via the electronic bus, to determine the speed and position of the cabin and its load.

In the above embodiment, the power supply to the cabin need only power the electronics and doors, and in certain applications power distribution to the cabin may not be required at all. Since each motor along the track is independently controlled and may be independently powered, it is possible to propel the cabin along part of the track even when a motor elsewhere on the track is non-operational. This can facilitate partial use of a linear track and almost full use of a looped track even while a short section of the track is non-operational or undergoing maintenance. As an example, in a large building where a fire is reported in one zone of the building, an elevator track that passes through the affected zone of the building may even be safely kept in use outside of the affected zone, which could significantly speed up the evacuation process.

In alternative embodiments, the traction rail (32) is stationary and forms part of the track (2) extending substantially its entire length, with the pinch-roller drive(s) (60) mounted on the cabin (1). In other respects, such embodiments and their variations may be similar to, or include features of, those discussed above in respect of previous embodiments, except that the pinch rollers (40, 41), spring-biasing/clamping arrangement (14, 56), and motor(s) (42) are located on the cabin (1) rather than the track, such as on or in the guide support frame (3). In this case, far fewer motors, gearboxes, and other electrical and mechanical parts are needed, saving significant cost, while many of the same advantages of nonlinear and/or looped tracks may still be achieved.

The power requirement to propel and raise the cabin may be lower in this arrangement, although in the previously discussed embodiments with motors all the way along the track, it is noted that, at any given instant, only those motor-driven rollers (40) that are actually in contact with a traction rail (32) need to be powered in order to propel the cabin (1). Therefore, where motors are mounted along a track, a transducer and signalling arrangement can be used to accurately determine the position of each cabin (1) travelling on the track (2), thereby enabling the pinch rollers (40, 41) and their respective motors (42) to be driven only when required, i.e. as the cabin passes the relevant section of track.

In any of the above embodiments, the system may be designed to provide certain functionality in the event of power loss to the motors. In preferred arrangements, the motors, gearboxes, and/or brakes are arranged to dissipate mechanical energy in a controlled manner in the event of power loss to a motor, so as to decelerate a moving cabin and/or to allow it to descend slowly under gravity to the nearest landing and then stop and open its doors, allowing passengers to exit safely.

The above embodiments are described by way of example only. Many variations are possible without departing from the scope of the invention as defined in the appended claims.

1. A transportation system comprising a cabin, a track along which the cabin is movable, an elongate traction member mounted on one of the cabin and the track, and a plurality of pinch rollers mounted on an other of the cabin and the track and arranged to grip the traction member, wherein at least one of said pinch rollers is motor driven to propel the cabin along the track by engagement with the traction member.

2. A transportation system according to claim 1 wherein the cabin is supported by engagement of the at least one motor-driven pinch roller with the traction member.

3. A transportation system according to claim 1 wherein the cabin is drivable along the track by engagement of the traction member between successive pairs of opposed pinch rollers.

4. A transportation system according to claim 1 comprising at least one opposed pair of pinch rollers, wherein one of the rollers in each opposed pair is driven by a motor.

5. A transportation system according to claim 3 arranged so that, when the traction member is fully engaged between said pair of opposed pinch rollers, the traction member is gripped sufficiently tightly between said opposed pinch rollers that substantially no slip, between the traction member and opposed pinch rollers can occur during operation.

6. A transportation system according to claim 3 wherein separation of the opposed pinch rollers is accommodated by flexion of a structural member on which they are mounted.

7. A transportation system according to claim 6 wherein the structural member is a beam aligned with a longitudinal axis of the track and said flexion is about said longitudinal axis.

8. A transportation system according to claim 6 further comprising resilient biasing means arranged to resist said flexion.

9. A transportation system according to claim 8 wherein the structural member is an I-beam and the resilient biasing means is arranged to urge relative rotation of flanges of the I-beam.

10. A transportation system according to claim 3 wherein the opposed pinch rollers are urged together by resilient biasing means.

11. A transportation system according to claim 8 wherein the biasing means is/are adjustably preloadable.

12. A transportation system according to claim 1 wherein the traction member is mounted on the cabin and the pinch rollers are mounted along the track.

13. A transportation system according to claim 1 wherein the traction member has tapered ends.

14. A transportation system according to claim 1 wherein the traction member is flexibly supported, such as rotatably supported.

15. A transportation system according to claim 1 wherein the traction member is mounted along the track and the pinch rollers are mounted on the cabin.

16. A transportation system according to claim 1 further comprising a guide that slidably constrains the cabin on the track.

17. A transportation system according to claim 16 wherein the guide comprises a guide rail and a guide shoe, one of the guide rail and shoe being mounted on the cabin and the other being mounted on the track.

18. A transportation system according to claim 16 comprising a support having two said guides on opposite sides thereof.

19. A transportation system according to claim 18 wherein the traction member is mounted on the support.

20. A transportation system according to claim 1 wherein at least one of said pinch rollers has an outer circumferential bearing surface having a profile that closely conforms to a bearing surface of the traction member.

21. A transportation system according to claim 1 wherein at least one of said pinch roller has an outer circumferential bearing surface having a concave profile.

22. A transportation system according to claim 1 wherein the traction member comprises a rail having a substantially circular cross-section.

23. A transportation system according to claim 1 wherein one or more of the traction member and pinch rollers comprises an ultra-high-strength alloy, such as a maraging steel alloy.

24. A transportation system according to claim 1 wherein at least a portion of the track is axially aligned in a substantially vertical direction.

25. A transportation system according to claim 1 wherein at least a portion of the track defines a curved path along which the cabin is drivable.

26. A transportation system according to claim 1 wherein the track defines a closed path.

27. A transportation system according to claim 1 wherein the track, the traction member and the pinch rollers are arranged to dissipate mechanical energy in a controlled manner in an event of power loss, so as to decelerate a moving cabin and/or to allow the cabin to descend slowly under gravity to a predefined position.

28. A transportation system according to claim 1 wherein the cabin is an elevator car.

29. A transportation system according to claim 1 wherein the track forms, or is mounted on, part of a building structure, such as within an elevator shaft.

30. (canceled)
